(19) United States
(12) Patent Application Publication
(10) Pub. No.: US 2012/0036782 A1
(43) Pub. Date: Feb. 16, 2012

(54) Door Actuator for HVAC System of Vehicle

(75) Inventors: Moo Yong Kim, Suwon-si (KR); June Kyu Park, Hwaseong-si (KR); Gyu Ik Han, Daejeon-si (KR)

(73) Assignees: HYUNDAI MOTOR COMPANY, Seoul (KR); HALLA CLIMATE CONTROL CORPORATION, Daejean-si (KR); KIA MOTORS CORPORATION, Seoul (KR)

(21) Appl. No.: 12/955,754

(22) Filed: Nov. 29, 2010

(30) Foreign Application Priority Data
Aug. 11, 2010 (KR) 10-2010-0082919

(51) Int. Cl. E05F 15/10

(52) U.S. Cl. 49/358

(57) ABSTRACT

A door actuator for an HVAC system of a vehicle includes a driving motor having a worm wheel and accommodated within a casing. An actuating gear has on an outer circumference thereof a worm thread that engages with the worm wheel, with an actuating thread being provided on a surface of the actuating gear. A change gear unit is hinged to the casing and rotatably engages with the actuating thread part. A solenoid unit rotates the change gear unit in a first or second direction. A first driving gear is provided at a predetermined position of the casing to engage with the change gear unit rotating in the first direction. A second driving gear is provided at a predetermined position of the casing to engage with the change gear unit rotating in the second direction.

### CROSS-REFERENCE TO RELATED APPLICATIONS

The present application claims priority to Korean Patent Application Number 10-2010-0082919 filed on Aug. 11, 2010, the entire contents of which application is incorporated herein for all purpose by this reference.

### BACKGROUND OF THE INVENTION

1. Field of the Invention

The present invention relates generally to a door actuator for a heating, ventilating and air conditioning (HVAC) system of a vehicle and, more particularly, to a door actuator for an HVAC system of a vehicle, which includes a change gear unit selectively engaging with a plurality of driving gears, thus allowing a plurality of doors to be actuated by a single motor.

2. Description of the Related Art

Generally, an HVAC system functions to keep the internal temperature, humidity, and air cleanliness and flow of a vehicle pleasant. The HVAC system has a passage in a casing to guide air blown by a blower. Heat exchangers are provided in the passage to heat or cool the blowing air. Further, several doors are mounted to the HVAC system to distribute the cool or warm air which has been cooled or heated by the heat exchangers to respective portions in the vehicle.

Such an HVAC system mainly includes an intake function, a mode function and a temp function. The intake function introduces ambient air into the vehicle or circulates air in the vehicle. The mode function controls the direction of air which flows from a duct of the HVAC system to a vent or a floor. The temp function controls the amount of the cool air that is mixed with the warm air, thus allowing air of a desired temperature to flow into the vehicle.

Meanwhile, as shown in FIG. 5A, a mode door actuator 1 performing the mode function and a temp door actuator 2 performing the temp function are installed, respectively, at a side of an HVAC system 3, thus actuating a mode door and a temp door.

For example, as shown in FIG. 5B, the conventional door actuator includes a pair of upper and lower casings 10 in which various parts are molded in a predetermined shape, a motor 11 which is provided in the upper and lower casings 10 and rotated forwards or backwards in response to an external signal, a worm gear 12 which is mechanically connected to an end of the motor 11 to control the torque and velocity of the motor 11, a gear unit G which has a helical gear 13 and spur gears 14 and 15, and a spur gear 16 which engages with the gear unit G to drive the door.

However, the conventional door actuator is problematic in that the mode door actuator for driving the mode door and the temp door actuator for driving the temp door are separately provided on the HVAC system, so that due to the use of the two door actuators, the cost of a product is higher, there are more assembly processes, and space utilization is poor.

### SUMMARY OF THE INVENTION

Accordingly, the present invention has been made keeping in mind the above problems occurring in the prior art, and various aspects of the present invention provide a door actuator for an HVAC system of a vehicle, which is intended to drive a plurality of doors using a single motor.

Certain aspects of the present invention provide a door actuator for an HVAC system of a vehicle including a driving motor, an actuating gear, a change gear unit, a solenoid unit, a first driving gear, and a second driving gear. The driving motor has a worm wheel and is accommodated in a casing. The actuating gear has on an outer circumference thereof a worm thread that engages with the worm wheel, with an actuating thread being provided on a surface of the actuating gear. The change gear unit is hinged to the casing and rotatably engages with the actuating thread part. The solenoid unit rotates the change gear unit in a first or second direction. The first driving gear is provided at a predetermined position of the casing to engage with the change gear unit rotating in the first direction. The second driving gear is provided at a predetermined position of the casing to engage with the change gear unit rotating in the second direction.

The door actuator may further include a first output gear engaging with the first driving gear and driven to transmit a driving force to a temp door which controls a temperature, and a second output gear engaging with the second driving gear and driven to transmit a driving force to a mode door which controls a direction of wind.

The change gear unit may include a main gear hinged to the casing via a rotating shaft and engaging at a first portion thereof with the actuating thread part, a sub gear engaging with a second portion of the main gear, and a rotary member connecting the main gear with the sub gear in such a way that the sub gear rotates about the rotating shaft of the main gear.

The solenoid unit may include a solenoid valve which is mounted to a predetermined portion of the casing, and an actuating rod which is connected to the solenoid valve in such a way as to move forwards and backwards and rotates the change gear unit in the first or second direction when the solenoid valve is operated.

The door actuator may further include a restraining lever which is hinged at a central portion thereof to the casing to restrain either of the first or second output gear when the change gear unit rotates.

The restraining lever may include a hinge member which is hinged at a central portion thereof to the casing, a moving groove which is formed in a first end of the hinge member in such a way as to be operated in conjunction with a rotation of the change gear unit and restrains a rotating part of the change gear unit, and a stopper which is provided on a second end of the hinge member in such a way as to be stopped by either of the first or second output gear when the hinge member rotates.

### BRIEF DESCRIPTION OF THE DRAWINGS

FIG. 1 is a perspective view showing the construction of an exemplary door actuator for an HVAC system of a vehicle according to the present invention.

FIG. 2 is a bottom view showing the door actuator of FIG. 1.

FIG. 3 is a plan view showing the exemplary door actuator for the HVAC system of the vehicle according to the present invention;

FIG. 4A is a view showing the operation of a first driving gear of the exemplary door actuator for the HVAC system of the vehicle according to the present invention;

FIG. 4B is a view showing the operation of a second driving gear of the exemplary door actuator for the HVAC system of the vehicle according to the present invention;

FIG. 5A is a perspective view showing a conventional HVAC system of a vehicle; and

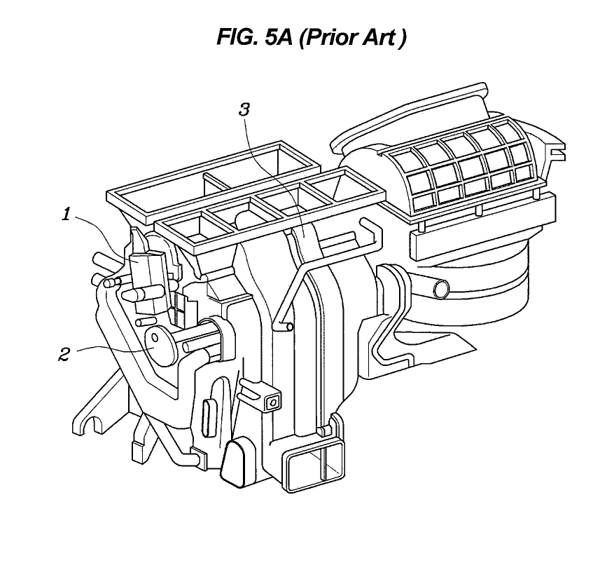

FIG. 5B is an exploded perspective view showing the construction of the conventional door actuator for an HVAC system of a vehicle.

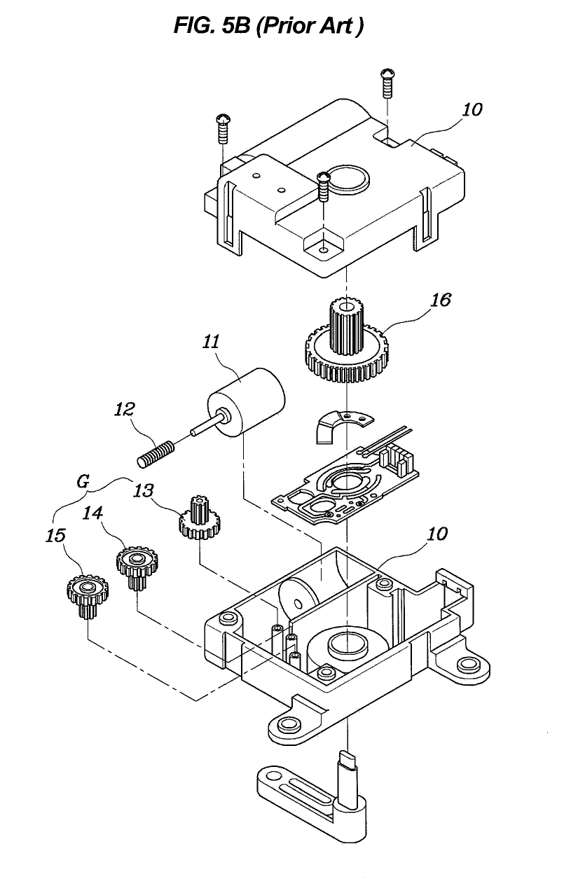

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

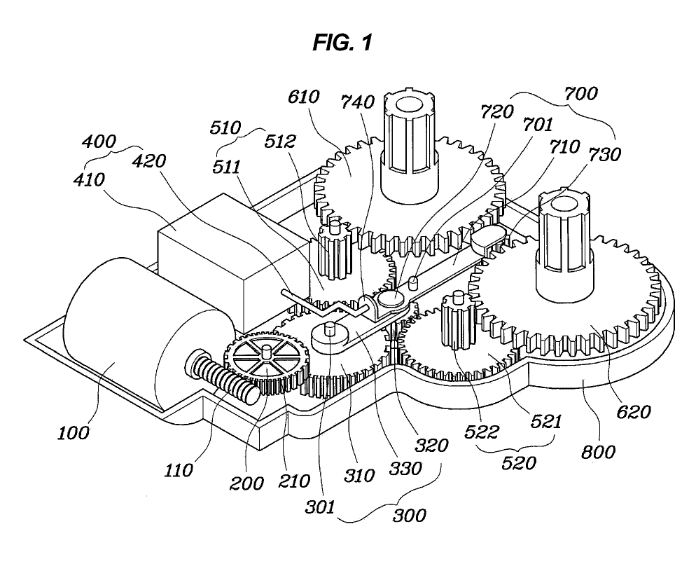

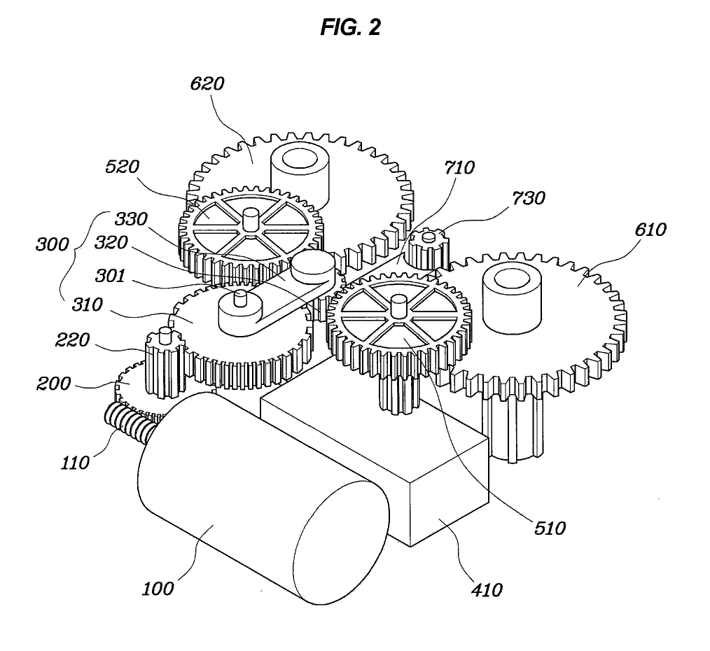

As shown in FIGS. 1 and 2, a door actuator according to the present invention is provided on an HVAC system to drive a plurality of doors using a single driving motor 100.

To this end, the door actuator includes a driving motor 100, an actuating gear 200, a change gear unit 300, a solenoid unit 400, a first driving gear 510, a second driving gear 520, a first output gear 610, a second output gear 620 and a restraining lever 700. First, the main construction of the door actuator will be described in brief.

The driving motor 100 provides an actuating force to the actuator via a worm wheel 110. The worm wheel 110 may be rotated clockwise or counterclockwise, and the door actuator may open or close the door depending on the direction of rotation of the worm wheel 110.

The actuating gear 200 functions to transmit the actuating force from the worm wheel 110 of the driving motor 100 to the change gear unit 300. To this end, the actuating gear 200 has on its outer circumference a worm thread 210 which meshes with the worm wheel 110. An actuating thread part 220 is provided on a surface of the actuating gear 200 to engage with the change gear unit 300.

The change gear unit 300 engages with the actuating thread part 220 of the actuating gear 200 to rotate in opposite directions. Such a rotating structure allows the change gear unit 300 to be selectively coupled to the first or second driving gear 510 or 520. Here, the change gear unit 300 is rotated by the solenoid unit 400.

The solenoid unit 400 pushes or pulls the change gear unit 300, thus rotating the change gear unit 300. Preferably, the solenoid unit 400 is placed to be perpendicular to the rotating change gear unit 300, and rotates the restraining lever 700, thus restraining the first or second output gear 610 or 620 that will be described below.

The restraining lever 700 is rotated in a direction opposite to the rotating direction of the change gear unit 300 by the operation of the solenoid unit 400. The restraining lever 700 restrains the first output gear 610 when the second output gear 620 is operated, and restrains the second output gear 620 when the first output gear 610 is operated.

In order to more clearly explain the above-mentioned construction, the construction according to various embodiments will be described below in detail with reference to the accompanying drawings.

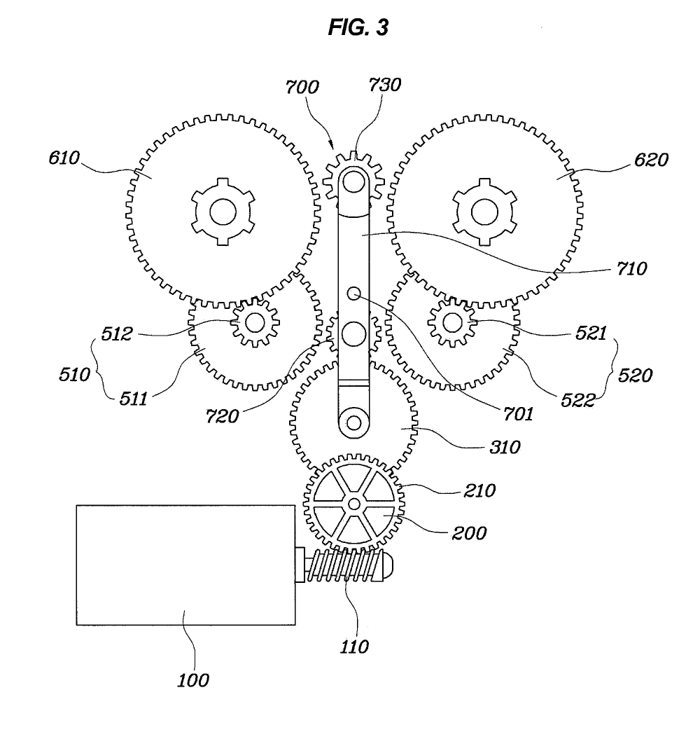

As shown in FIGS. 1 to 3, the driving motor 100 is mounted on a base such as casing 800 of the HVAC system, and has on its rotating shaft the worm wheel 110 that engages with the actuating gear 200. The worm wheel 110 is placed perpendicular to the actuating gear 200, and is connected to the change gear unit 300 via the actuating gear 200 to be driven. One will appreciate that the base may be a casing that houses the driving motor, worm wheel, gears, change gear unit and/or other components such as the illustrated casing 800.

The change gear unit 300 is hinged to the casing 800 via a rotating shaft 301 and rotated by the rotation of the actuating gear 200. Such a change gear unit 300 includes a main gear 310, a sub gear 320 and a rotary member 330.

The main gear 310 of the change gear unit 300 comprises a spur gear which is hinged to the casing 800 via the rotating shaft 301. A portion of the main gear 310 engages with the actuating thread part 220, so that the actuating force of the actuating gear 200 is transmitted to the main gear 310. The sub gear 320 comprises a spur gear which engages with another portion of the main gear 310, and moves along the outer circumference of the main gear 310 when the main gear 310 rotates. The rotary member 330 connects the rotating shaft 301 of the main gear 310 with the rotating shaft of the sub gear 320, and guides the movement of the sub gear 320 so that the sub gear 320 rotates about the rotating shaft 301 of the main gear 310.

The solenoid unit 400 is installed at a position in the casing 800, and rotates the change gear unit 300 in opposite directions. To this end, the solenoid unit 400 includes a solenoid valve 410 which is mounted to a portion of the casing 800, and an actuating rod 420 which is connected to the solenoid valve 410 in such a way as to move forwards and backwards. Preferably, the actuating rod 420 is placed at a side of the change gear unit 300, so that the front end of the actuating rod 420 is connected to a connection lug 740 of the restraining lever 700 which will be described below. The connection lug 740 has a space (not shown) in which the front end of the actuating rod 420 is movable for the smooth operation of the actuating rod 420.

That is, if the solenoid valve 410 is operated in response to an actuating signal of a control unit (not shown), the actuating rod 420 is moved forwards and backwards relative to the solenoid valve 410 by the operation of the solenoid valve 410. Here, since the actuating rod 420 is placed at a side of the change gear unit 300, it may rotate the change gear unit 300 in opposite directions.

In various embodiments, the actuating rod 420 is connected to the connection lug 740 of the restraining lever 700. However, the present invention is not limited to the disclosed embodiments. That is, the actuating rod 420 may be connected to the rotary member 330 of the change gear unit 300 to rotate the rotary member 330 of the change gear unit 300 when the actuating rod 420 moves forwards and backwards.

The first driving gear 510 is provided at a position in the casing 800, and selectively engages with the change gear unit 300 to be rotated. The first driving gear 510 includes on its outer circumference a first driving thread 511 which may engage with the sub gear 320 of the change gear unit 300. A first driving thread part 512 is provided on a surface of the first driving gear 510 to engage with the first output gear 610.

For example, in the state in which the sub gear 320 engages with the first driving thread 511 by the change gear unit 300 rotating in one direction, when the worm wheel 110 of the driving motor 100 is rotated, the rotating force of the worm wheel 110 is transmitted through the change gear unit 300 to the first driving gear 510, and the rotating force is transmitted through the first driving thread part 512 of the first driving gear 510 to the first output gear 610.

The second driving gear 520 is provided at a position in the casing 800, and selectively engages with the change gear unit 300 to be rotated. The second driving gear 520 includes on its outer circumference a second driving thread 521 which may engage with the sub gear 320 of the change gear unit 300. A second driving thread part 522 is provided on a surface of the second driving gear 520 to engage with the second output gear 620.

That is, after the sub gear 320 engages with the second driving thread 521 of the second driving gear 520 by the change gear unit 300 rotating in the other direction, when the worm wheel 110 of the driving motor 100 is rotated, the rotating force of the worm wheel 110 is transmitted through the change gear unit 300 to the second driving gear 520, and the rotating force is transmitted through the second driving thread part 522 of the second driving gear 520 to the second output gear 620.

In various embodiments, the first driving gear 510 engages directly with the first output gear 610, and the second driving gear 520 engages directly with the second output gear 620. A plurality of spur gears (not shown) may be provided between the first driving gear 510 and the first output gear 610 or between the second driving gear 520 and the second output gear 620, thus adjusting the rotating force by changing a gear ratio, or changing the rotating direction of the gears. Here, a spur gear is a general spur gear for transmitting a rotating force between gears. A gear rotating direction may be changed using odd or even spur gears.

The first output gear 610 is provided at a position in the casing 800 in such a way as to be operated in conjunction with the first driving gear 510, and transmits a driving force to a temp door which controls the temperature. That is, since the first output gear 610 engages with the first driving thread part 512 of the first driving gear 510, the rotating force of the first driving gear 510 may be transmitted to the temp door.

The second output gear 620 is provided at a position in the casing 800 in such a way as to be operated in conjunction with the second driving gear 520, and transmits a driving force to a mode door which controls the direction of the wind. That is, since the second output gear 620 engages with the second driving thread part 522 of the second driving gear 520, the rotating force of the second driving gear 520 may be transmitted to the mode door.

In various embodiments, the first output gear 610 is connected to the temp door to actuate the temp door, and the second output gear 620 is connected to the mode door to actuate the mode door. However, the first output gear 610 may be connected to the mode door, and the second output gear 620 may be connected to the temp door as suits the design conditions imposed by the peripheral parts.

The first output gear 610 or the second output gear 620 is selectively restrained by the restraining lever 700.

The restraining lever 700 is hinged at its central portion to the casing 800, and restrains one output gear when the other output gear is operated. In detail, the restraining lever 700 restrains the second output gear 620 when the first output gear 610 is operated by the driving motor 100, and restrains the first output gear 610 when the second output gear 620 is operated by the driving motor 100.

In order to realize the above operation, the restraining lever 700 may include a hinge member 710, a moving groove 720, and a stopper 730.

The central portion of the restraining lever 700 is hinged to the casing 800 via a hinge shaft 701 in such a way that opposite ends of the hinge member 710 are rotated. The moving groove 720 is formed in one end of the hinge member 710 to restrain the rotating shaft of the sub gear 320. The stopper 730 is provided on the other end of the hinge member 710 and has on its outer circumference a thread so that the stopper 730 is stopped by either the first or second output gear 610 or 620 when the hinge member 710 rotates.

Thus, when the sub gear 320 rotates to one side of the casing 800 and engages with the first driving gear 510, the other end of the restraining lever 700 rotates to the other side of the casing 800, so that the stopper 730 engages with the second output gear 620. Meanwhile, when the sub gear 320 rotates to the other side of the casing 800 and engages with the second driving gear 520, the other end of the restraining lever 700 rotates to one side of the casing 800, so that the stopper 730 engages with the first output gear 610.

Preferably, in order to smoothly rotate the restraining lever 700, a spacing distance between the hinge shaft 701 and the moving groove 720 becomes shorter or the moving groove 720 comprises a long groove which extends in the longitudinal direction of the restraining lever 700. Thereby, when the sub gear 320 rotates, the rotating shaft of the sub gear 320 may move in the longitudinal direction of the restraining lever 700.

The operation of the present invention constructed as described above will be described below.

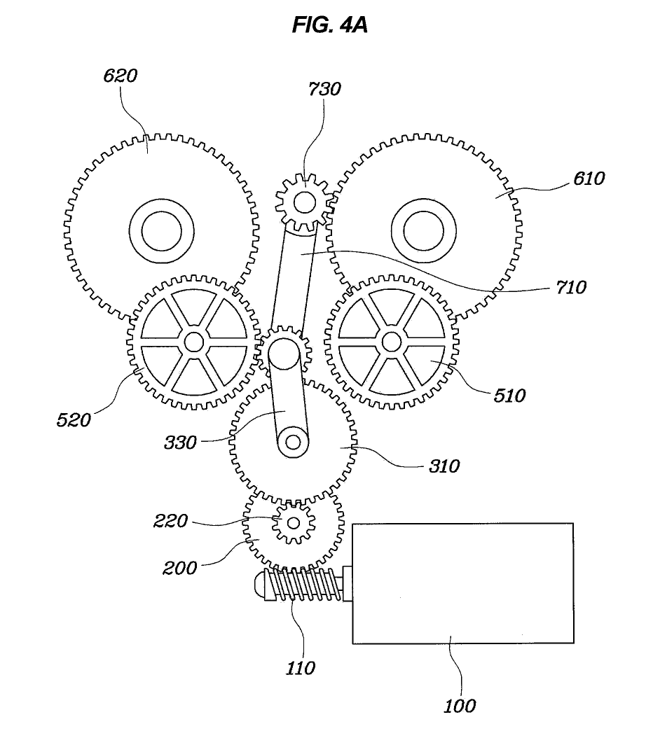

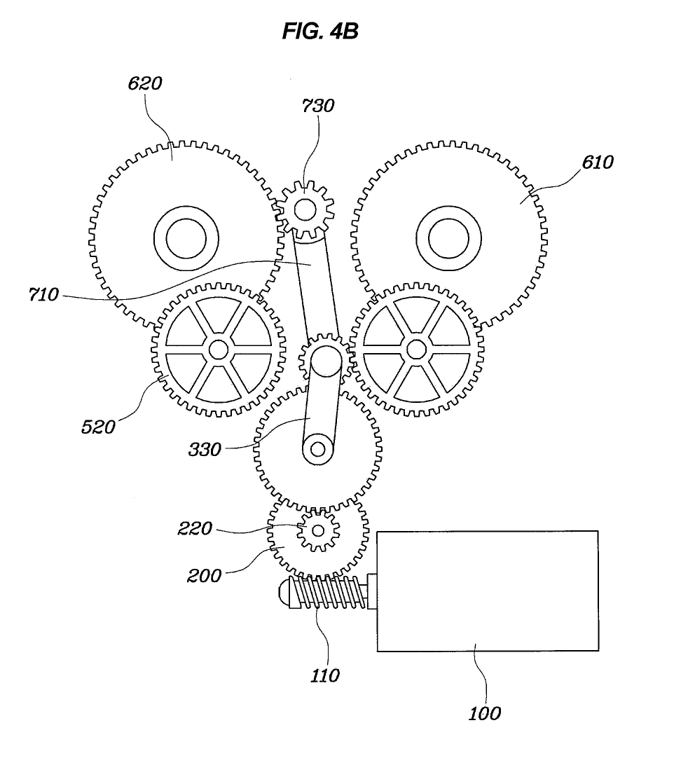

First, as shown in FIG. 4A, if the solenoid valve 410 is operated so that the actuating rod 420 moves to one side of the casing 800, the stopper 730 of the restraining lever 700 rotates to the other side of the casing 800 and engages with the second output gear 620. Simultaneously, the sub gear 320 rotates to one side of the casing 800 and thus engages with the first driving gear 510.

Subsequently, if the worm wheel 110 of the driving motor 100 is rotated, the rotating force of the worm wheel 110 is transmitted through the actuating gear 200, the main gear 310 and the sub gear 320 to the first driving gear 510, and the rotating force transmitted to the first driving gear 510 is transmitted to the first output gear 610, thus driving the temp door that controls the temperature.

Meanwhile, as shown in FIG. 4B, if the solenoid valve 410 is operated so that the actuating rod 420 moves to the other side of the casing 800, the stopper 730 of the restraining lever 700 rotates to one side of the casing 800 and engages with the first output gear 610. Simultaneously, the sub gear 320 rotates to the other side of the casing 800 and thus engages with the second driving gear 520.

Subsequently, if the worm wheel 110 of the driving motor 100 is rotated, the rotating force of the worm wheel 110 is transmitted through the actuating gear 200, the main gear 310 and the sub gear 320 to the second driving gear 520, and the rotating force transmitted to the first driving gear 510 is transmitted to the first output gear 610, thus driving the temp door that controls the temperature.

As described above, the present invention achieves the following remarkable effects.

First, the present invention is advantageous in that a solenoid valve and an actuating rod are arranged in parallel, so that space utilisation is better in comparison with a configuration wherein a solenoid valve and an actuating rod are arranged in series, and the entire length of a casing may be reduced.

Second, the present invention is advantageous in that a single motor provided in a door actuator may drive a plurality of doors, so that the manufacturing cost thereof is reduced, the number of assembly processes is reduced, and space utilization is improved.

Third, the present invention is advantageous in that it has a simple structure which selectively changes gears using a solenoid valve, thus selectively actuating a plurality of doors, therefore improving the operation feeling and reliability of a product.

For convenience in explanation and accurate definition in the appended claims, the terms “upper” or “lower”, “front”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door actuator for an HVAC system of a vehicle, comprising:
a driving motor having a worm wheel and mounted on a base;
an actuating gear having a worm thread on an outer circumference thereof that engages with the worm wheel, with an actuating thread part being provided on a surface of the actuating gear;
a change gear unit hinged to the base and rotatably engaging with the actuating thread part;
a solenoid unit pivoting the change gear unit in a first or second direction;
a first driving gear provided at a predetermined position of the base to engage with the change gear unit when pivoted in the first direction; and
a second driving gear provided at a predetermined position of the base to engage with the change gear unit when pivoted in the second direction.

2. The door actuator as set forth in claim 1, further comprising:
a first output gear engaging with the first driving gear and driven to transmit a driving force to a temp door which controls a vehicle temperature; and
a second output gear engaging with the second driving gear and driven to transmit a driving force to a mode door which controls a direction of air flow.

3. The door actuator as set forth in claim 1, wherein the change gear unit comprises:
a main gear hinged to the base via a rotating shaft, a first portion of the main gear engaging with the actuating thread part;
a sub gear engaging with a second portion of the main gear; and
a rotary member connecting the main gear with the sub gear in such a way that the sub gear rotates about the rotating shaft of the main gear.

4. The door actuator as set forth in claim 1, wherein the solenoid unit comprises:
a solenoid valve mounted to a predetermined portion of the base; and
an actuating rod connected to the solenoid valve in such a way as to move forwards and backwards, and pivoting the change gear unit in the first or second direction when the solenoid valve is operated.

5. The door actuator as set forth in claim 2, further comprising:
a restraining lever hinged at a central portion thereof to the base to restrain either of the first or second output gear when the change gear unit rotates.

6. The door actuator as set forth in claim 5, wherein the restraining lever comprises:
a hinge member hinged at a central portion thereof to the base;
a moving groove formed in a first end of the hinge member in such a way as to be operated in conjunction with a rotation of the change gear unit, and restraining a rotating part of the change gear unit; and
a stopper provided on a second end of the hinge member in such a way as to be stopped by either of the first or second output gear when the hinge member rotates.

7. The door actuator as set forth in claim 1, wherein the base is a casing that encloses the driving motor, the change gear unit, the first driving gear, and the second driving gear.
